(19) United States
(12) Patent Application Publication
(10) Pub. No.: US 2025/0074741 A1
(43) Pub. Date: Mar. 6, 2025

(54) MANAGEMENT OF SERVICE PROVISION IN ELEVATOR SYSTEM

(71) Applicant: KONE Corporation, Helsinki (FI)

(72) Inventors: Markku Kakko, Helsinki (FI); Janne Sorsa, Helsinki (FI); Salla Mannerjoki, Helsinki (FI); Harri Länsiö, Helsinki (FI); Pasi Raitola, Helsinki (FI)

(73) Assignee: KONE Corporation, Helsinki (FI)

(21) Appl. No.: 18/947,322

(22) Filed: Nov. 14, 2024

Related U.S. Application Data
(63) Continuation of application No. PCT/FI2022/050413, filed on Jun. 14, 2022.

(51) Int. Cl. B66B 1/34; B66B 5/00

(52) U.S. Cl. CPC B66B 1/3407; B66B 5/0012; B66B 2201/21; B66B 2201/403

(57) ABSTRACT

A method for managing an elevator service to a floor by an elevator system is provided, the method including: generating a first estimation on an aggregate need of an elevator service for a group of individuals in a predefined area, the aggregate need being generated by combining a number of estimations descriptive on a need of the elevator service by each individual at a first instant of time; comparing the first estimation to a first reference value; generating a first control signal to reserve a number of elevators to serve a section the floor belongs to in response to a detection that the first estimation fulfills a condition defined by the first reference value. A control system, an elevator system, and a computer readable medium are also provided.

### TECHNICAL FIELD

The invention concerns in general the technical field of elevator systems. More particularly, the invention concerns a management of a service provision by the elevator systems.

### BACKGROUND

Typical way to indicate a request for an elevator service is that an individual provides the request through a user interface of the elevator system at a floor the individual resides. Other approaches based on a utilization of sensor systems are also introduced. These are typically based on a detection of individuals in a lobby from the sensor data and generate elevator calls, i.e. service requests, on a basis of the sensor data. The solutions based on automatic generation of the elevator calls are vulnerable to errors due to that it is difficult to make conclusions from the sensor data if certain individuals are really in need of elevator service or if they are only roaming in an area monitored with the sensors.

A document EP 3421401 A1 describes a prior art solution in which an intent of an individual to board into an elevator is evaluated based on sensor data. A plurality of characteristics derivable from the individual are evaluated and based on that it is concluded if the elevator service is needed or not.

The approaches known so far may be operative in some situation, but they are still prone to errors, i.e. the request for the elevator service is generated but it eventually turns out that such a need is not actually present, since no individual enters the elevator car even if the car is instructed to the floor in question. The uncertainty in the operation causes unnecessary reserve of resources but also waste of energy and dissatisfaction of passengers who really need the elevator service.

Hence, there is need to introduce further approaches mitigating at least in part at least some of the drawbacks of the prior art solutions.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control system, an elevator system, and a computer program for managing an elevator service.

The objects of the invention are reached by a method, a control system, an elevator system, and a computer program as defined by the respective independent claims.

According to a first aspect, a method for managing an elevator service to a floor by an elevator system is provided, the method, performed by a control system, comprises:
generating a first estimation on an aggregate need of an elevator service for a group of individuals in a predefined area, the aggregate need for the group of individuals is generated by combining a number of estimations descriptive on a need of the elevator service by each individual in the predefined area at a first instant of time,
comparing the first estimation to a first reference value,
generating a first control signal to reserve a number of elevators belonging to the elevator system to serve a section the floor belongs to in response to a detection that the first estimation fulfills a condition defined by the first reference value.

The method may further comprise:
generating a second estimation on the aggregate need of an elevator service for a group of individuals in the predefined area, the aggregate need for the group of individuals is generated by combining a number of estimations descriptive on a need of the elevator service by each person in the predefined area at a second instant of time,
comparing the second estimation to a second reference value,
performing, in accordance with a comparison between the second estimation to the second reference value, one of: i) generate a second control signal to instruct at least one elevator among the number of the elevators reserved to serve the section the floor belongs to, ii) release the number of the elevators reserved to serve the section the floor belongs to.

The number of estimations descriptive on a need of the elevator service by each individual in the predefined area may e.g. be generated based on data obtained from one or more sensors arranged to monitor the predefined area. The one or more sensors may be image capturing devices.

Still further, a number of characteristics of an individual may be evaluated to generate the estimation descriptive on the need of the elevator service by the individual. For example, the number of characteristics of the individual may comprise at least one of the following: a location of the individual in the predefined area; a movement of the individual in the predefined area; a posture of the individual; a gaze direction of the individual.

The first estimation and the second estimation may be determined to express a probability of the aggregate need of the elevator service by the group of individuals.

The first estimation and the second estimation may be expressed as a statistical value with respect to an individual in the predefined area.

Moreover, the second reference value may be defined to require larger aggregate need of the elevator service than the first reference value.

According to a second aspect, a control system for managing an elevator service to a floor by an elevator system is provided, the control system configured to:
generate a first estimation on an aggregate need of an elevator service for a group of individuals in a predefined area, the aggregate need for the group of individuals is generated by combining a number of estimations descriptive on a need of the elevator service by each individual in the predefined area at a first instant of time,
compare the first estimation to a first reference value,
generate a first control signal to reserve a number of elevators belonging to the elevator system to serve a section the floor belongs to in response to a detection that the first estimation fulfills a condition defined by the first reference value.

The control system may further be configured to:
generate a second estimation on the aggregate need of an elevator service for a group of individuals in the predefined area, the aggregate need for the group of individuals is generated by combining a number of estimations descriptive on a need of the elevator service by each person in the predefined area at a second instant of time,
compare the second estimation to a second reference value,
perform, in accordance with a comparison between the second estimation to the second reference value, one of: i) generate a second control signal to instruct at least one elevator among the number of the elevators reserved to serve the section the floor belongs to, ii) release the number of the elevators reserved to serve the section the floor belongs to.

For example, the control system may be configured to generate the number of estimations descriptive on a need of the elevator service by each individual in the predefined area based on data obtained from one or more sensors arranged to monitor the predefined area. The control system may be configured to obtain the data from one or more sensors being image capturing devices.

Still further, the control system may be configured to evaluate a number of characteristics of an individual to generate the estimation descriptive on the need of the elevator service by the individual. For example, the number of characteristics of the individual comprises at least one of the following: a location of the individual in the predefined area; a movement of the individual in the predefined area; a posture of the individual; a gaze direction of the individual.

The control system may be configured to determine the first estimation and the second estimation to express a probability of the aggregate need of the elevator service by the group of individuals.

The control system may also be configured to express the first estimation and the second estimation as a statistical value with respect to an individual in the predefined area.

Still further, the second reference value may be defined to require larger aggregate need of the elevator service than the first reference value.

According to a third aspect, an elevator system is provided, the elevator system comprising:
a number of elevators,
a control system according to the second aspect as defined above.

The elevator system may further comprise one or more sensors configured to obtain data for generating a number of estimations descriptive on a need of the elevator service by each individual in the predefined area.

According to a fourth aspect, a computer program is provided, the computer program comprising computer readable program code configured to cause performing of the method according to the first aspect as defined above when the computer readable program code is run on one or more computing apparatuses.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically aspects in relation to the invention according to an example.

FIG. 3 illustrates schematically a method according to an example.

FIG. 4 illustrates schematically a further method according to an example.

FIG. 5 illustrates schematically an apparatus suitable for performing an operation of a control system according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

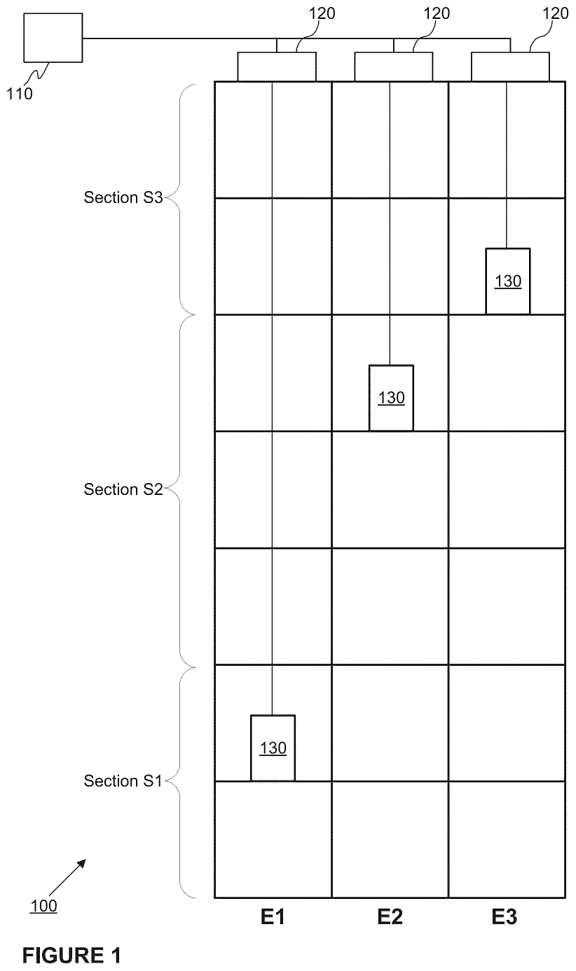

FIG. 1 illustrates schematically an example of an elevator system 100 into which the present invention may be implemented to. The elevator system 100 according to the example consists of a group of elevators E1, E2, E3 controlled by a control system 110 aka. a group controller. Each elevator E1, E2, E3 may e.g. have one elevator car 130 arranged to serve floors in shafts and the motion to the elevator cars 130 is generated with a machinery 120 arranged to each elevator E1, E2, E3 in a known manner. The machineries 120 are controlled by the control system 110 which may be arranged to have an overall responsibility of an operation of the elevator system 100. For sake of completeness it is worthwhile to mention that the elevator system 100 comprises many other entities and devices not shown in FIG. 1 for clarity reason.

In accordance with the example embodiment shown in FIG. 1 the floors served by the elevator system 100 are divided to belong to predefined sections denoted with a section S1, a section S2, and a section S3 in FIG. 1. The division to the sections may be arranged in any applicable manner to serve the purpose in the most appropriate way. The number of floors belonging to the sections may be one or more and the number of floors may vary between the sections if desired. The information disclosing the division of the floors to the sections is available to the control system 110, e.g. it may be stored in data storage accessible by the control system 110.

For sake of clarity it is worthwhile to emphasize that FIG. 1 illustrates an example of the elevator system 100 into which the present invention may be implemented to, and it may comprise further entities as is described in the forthcoming description. Further, the elevator system 100 may comprise one or more elevators E1, E2, E3. The number of elevators E1, E2, E3 may e.g. be dependent on characteristics of premises into which the elevator system 100 is implemented to. For example, the premises may be a building or a ship or anything similar.

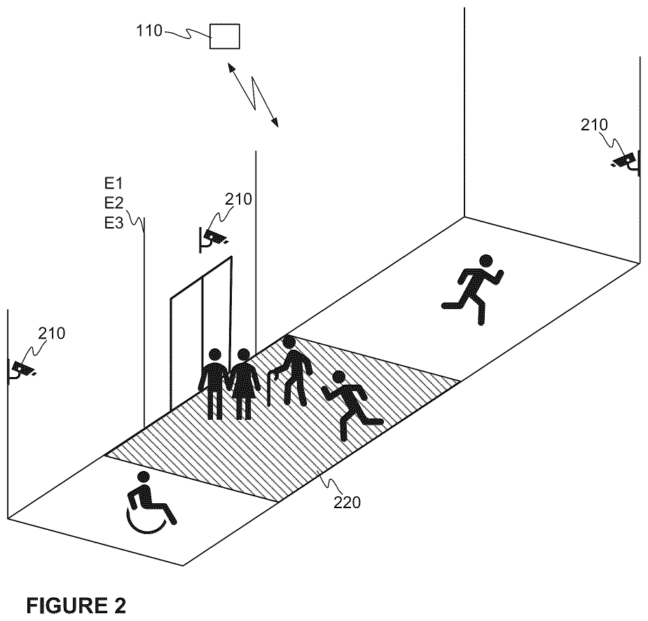

FIG. 2 illustrates schematically some further aspects in relation to the invention. Namely, FIG. 2 illustrates schematically an example of a floor with respect to which an elevator service in accordance with the present invention may be arranged. The space in the premises according to the non-limiting example of FIG. 2 may be a corridor type in which individuals may roam in the premises. There is arranged an elevator E1, E2, E3 of an elevator system 100 to serve individuals in the premises to access other floors from the floor shown in FIG. 2. The floor in question may be equipped with one or more sensors 210 in order to generate measurement data descriptive on individuals in the space. In accordance with an example embodiment the sensors 210 may e.g. be image capturing devices capable of generating image data to be analyzed in a manner as is described in the forthcoming description. The term image capturing device shall be understood in a broad manner and to comprise digital cameras, depth cameras, thermal image cameras, and the like. The measurement data obtained from the sensors 210 may be delivered to the control system 110 either directly or through a mediator device being e.g. a computing device configured to perform image analysis. The image analysis may also be arranged to be performed by the control system 110 of the elevator system 110 and/or these two may be considered to form a control system 110 having a distributed computing environment. The analysis may be performed by the control system 110 to data descriptive on a predefined area 220 in the space. The predefined area may be defined by configuring an analysis software to perform the analysis only to the measurement data representing the area 220 or the sensors 210 may be arranged so that they generate measurement data only from the predefined area, which is then analyzed. In the latter case it may be considered that the operative area of the respective sensor 210, or sensors 210, define the predefined area 220. It is also worthwhile to understand that a plurality of floors in the premises may be equipped in the same manner as shown in FIG. 2.

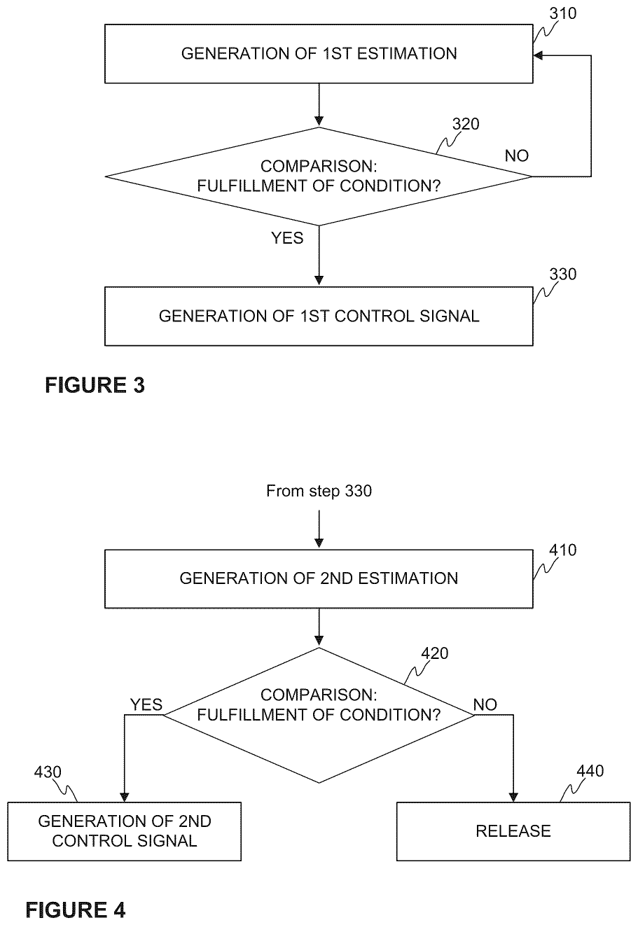

Next, further aspects in relation to the invention are described by referring to FIG. 3 schematically illustrating an example of a method according to the invention. At least one aim of the invention is to manage, or control, an elevator service with respect to a floor by controlling an operation of the elevator system 100 in accordance with a result of estimation on a need of the elevator service by individuals. The management of the elevator service to the floor by the elevator system 100 comprises that the control system 110 is configured to generate 310 a first estimation on an aggregate need of an elevator service for a group of individuals in a predefined area 220. In other words, the first estimation is generated 310 based on data indicating the need of the elevator service by the individuals residing in the predefined area 220. The aggregate need for the group of persons is generated by combining a number of estimations descriptive on a need of the elevator service by each person in the predefined area 220 at a first instant of time. The combining of the number of estimation may correspond to summing up probabilities determined for each individual residing in the predefined area 220 at the first instant of time wherein the first instant of time may correspond to the instant of time the data is obtained from the one or more sensors 210.

The estimation generated to an individual in the predefined area 220 may relate to evaluating of behavioral aspects of the individual from the data obtained with the sensors 210. The behavioral aspects may be descriptive of a number of characteristics by means of which it may be generated an estimation, cf. a probability, on the individual's need of the elevator service. The characteristics taken into account may e.g. relate to a location of the individual in the predefined area 220, a movement of the individual in the predefined area 220, a posture of the individual, a gaze direction of the individual, and so on. At least some of the evaluated characteristics may require measurement data from a number of instances in time, such as the movement of the individual, in order to generate an estimation in those regard and, therefore, the monitoring of the predefined area 210 may be arranged in a continuous manner. When evaluating characteristics requiring a plurality of data samples over a time window, the data samples may be collected prior the instant of time defined for generating 310 the first estimation and the last piece of data used in the evaluation may be the instant of time in question. For each of the evaluated characteristics it may be generated a value which may be combined together in order to generate the estimation for the individual in question. In other words, the generation of the estimation for each individual is based on a predefined mathematical algorithm into which a number of values derivable from one or more image data captured with one or more the sensors 120 are input and the algorithm may be arranged to generate a probability on the need of the elevator service for the individual in question. For example, if the individual stands still in front of an elevator door and gazes to a display showing a floor the elevator car resides, the algorithm may be configured to generate high probability to that individual. Contrary to that, it may occur that another individual resides in the predefined area 220 and it is detected that the individual moves in the area 220 and does not indicate, e.g. based on gaze, any interest to the elevator E1, E2, E3, the probability indicative of the need of elevator service may be set low by the algorithm for the individual in question. For sake of clarity it is worthwhile to mention that the algorithm may be defined by a specialist based on some input data available and/or the algorithm may be self-learning using some predefined machine-learning mechanism. The machine-learning may be arranged by following the behavior of the individuals until it is clear if the elevator service is needed or not and arrange the self-learning algorithm to apply that information in training itself to detect the situation in a better way through the training.

As said, the described estimation descriptive on the need of the elevator service is generated for each person in the predefined area 220 and by combining the estimations of the individuals the first estimation may be generated 310. The first estimation is an aggregate need, or estimation, of the needs of the elevator service by the individuals in the predefined area 220. The first estimation may be understood as a value descriptive of a probability for the group of individuals for the need of the elevator service. It may be formed to a one or more individuals in the predefined area 220 as is directly derivable.

In response to the generation 310 of the first estimation the control system 110 is configured to compare 320 the first estimation to a first reference value. The first reference value may be set so that it defines a condition whose fulfillment may be interpreted to correspond to that there is a probability among the individuals in the predefined area 220 that elevator service may be needed soon. In other words, the first reference value may be understood to define a trigger level at which measures may be taken to prepare the elevator system 100 for providing service to the floor in question in a manner that creates user satisfaction, but at the same time filters out erroneous decisions of the service need at least to some extent. The comparison 320 operation may generate as an output an indication that the condition defined by the first reference level is not fulfilled which may cause a continued monitor of the predefined area 220 and individuals therein, and a re-generation first estimation at another instant of time. On the other hand, if the condition defined by the first reference value is fulfilled, the control system 110 may be configured to generate 330 a first control signal as is described in the forthcoming description. For sake of clarity it is here mentioned that the fulfillment of the condition with respect to the first reference value may correspond to a situation that the first estimation exceeds, or equals, to the first reference in value. Alternatively, it may be arranged that the fulfillment of the condition with respect to the first reference value may correspond to a situation that the first estimation is less, or equals, than the first reference in value. The implementation depends on the way how the first estimation is generated 310. In a typical implementation the fulfillment of the condition is judged if the first estimation exceeds the first reference value.

In at least some implementations the first estimation combining the individuals' estimations may be an average value calculated from the summed individual estimate values divided by a number of individuals in the predefined area 220.

This is advantageous approach since the number of individuals in the area may vary and, therefore, some statistical value, such as the average value, as a representative of the aggregate value is preferred since it helps in selecting the first reference value. Another option is of course to adjust the first reference value in accordance with the number of individuals detected in the predefined area 220 prior to the comparison 320 is done.

As mentioned, in accordance with the invention the control system 110 is configured to generate 330 a control signal in response to the detection in the comparison 320 that that the first estimation fulfills the condition defined by the first reference value. The control signal is generated so that it causes a reservation a number of elevators E1, E2, E3 belonging to the elevator system 100 to serve a section S1, S2, S3 into which the floor from which the measurement data is obtained with the sensors 210 belongs to. If the control system 110 is the elevator controller the control signal may be internal signal which causes a selection of at least one elevator E1, E2, E3 among the number of elevators E1, E2, E3 e.g. based on various parameters, such as their current allocation of service calls, to prioritize serving the section S1, S2, S3 into which the floor belongs to. Naturally, if the control system 110 differs from the elevator controller the control system 110 may generate the respective control signal to the elevator controller. In any case, the controller configured to control the elevator system 100 causes a re-arrangement in a provision of service by the elevators E1, E2, E3 in the premises so that at least one elevator E1, E2, E3 prioritizes the section S1, S2, S3 in an emphasized manner. As a non-limiting example the prioritization may refer to an arrangement in which the at least one elevator E1, E2, E3 is set to serve only the section S1, S2, S3 in question, e.g. by bringing passengers to those floors from a ground floor and away therefrom to the ground floor.

In view to the method according to an example embodiment of the invention as described above an advantage gained with it is that it balances an uncertainty of monitoring solutions evaluating user behavior in triggering an elevator service provision but at the same time prepares the elevator system 100 for serving the floor from which the sensor data is obtained.

In response to the setting the elevator system 100 to operate in the described manner, i.e. at least one elevator E1, E2, E3 is prioritizing the section S1, S2, S3 in which the floor in question resides, the monitoring of the floor and especially the predefined area 220 may be continued. The further steps in accordance with an example embodiment are shown in FIG. 4. In response to the continuation of the monitoring a second estimation may be generated 410 while the elevator system 100 is set to the mode preparing the elevator system 100 to serve the floor. The second estimation is again generated 410 to describe the aggregate need of an elevator service for a group of individuals in the predefined area 220 at a second instant of time. Depending on the implementation the second estimation may be generated 410 based on measurement data obtained only at the second instant of time or it may be based on a measurement data obtained at a plurality instants of time in the manner as discussed in the context of the generation 310 of the first estimation in the foregoing description. The second instant of time, or the time window applied in the generation 410 of the second estimate, may be defined to be after applicable period of time after the generation of the first estimation so that meaningful information may be captured. This approach refers to an assumption that the situation in the predefined area 220 is continuously changing and, as a result, the second estimation generated in the same manner as the first estimation but at another instant of time, or at another time window, differs from the first estimation at a high probability due to that the situation changes in the predefined area 220. In other words, some new individuals may enter the predefined area 220 as well as some other may leave the area 220. Still further, the locations of the individuals in the predefined area 220 may change and the same may occur with respect to other characteristics included in the generations of the estimations 310, 410. For sake of completeness it is here mentioned that the second estimate being indicative on the aggregate need of the elevator service is also generate by combining estimations generated for each individual in the predefined area 220 at the second instant of time wherein behavioral aspects of the individual are evaluated based on data obtained with the sensors 210.

Next, the generated second estimation is compared 420 to a second reference value. The second reference value, in turn, may be set so that it defines a condition whose fulfillment may be interpreted to correspond to that there is a high probability among the individuals in the predefined area 220 that elevator service is needed. In other words, the second reference value may be understood to define a trigger level at which the control system 110 is configured to perform further measures, i.e. either to generate 430 a second control signal to instruct at least one elevator E1, E2, E3 among the number of elevators E1, E2, E3 reserved to serve the section S1, S2, S3 the floor belongs to, or to release 440 the current mode of operation by the elevator system 100. The comparison 420 operation may generate as an output an indication that the condition defined by the second reference level is fulfilled or not. In case the condition is fulfilled on the basis of the comparison the control system 110 is configured to generate 430 a second control signal causing e.g. a generation of a service call, i.e. an elevator call, to the elevator system 100 so that at least one elevator car 130 of the reserved elevators E1, E2, E3 arrives at the floor in question to serve the one or more individuals therein. The second control signal as such may be considered as the service call in at least some implementations. On the other hand, if the condition defined by the second reference level is not fulfilled in the comparison 420 the control system 110 may be configured to release 440 the mode in which at least one elevator E1, E2, E3 of the elevator system 100 is arranged to serve the section S1, S2, S3 into which the floor belongs to. The releasing 440 may be achieved by generating such a control signal to an entity controlling the operational modes of the elevator system 110, which entity may e.g. be the control system 110 itself or the elevator controller if it is separate to the control system 110. In other words, in response to the releasing 440, the elevator system 100 is returned to a normal mode.

For sake of clarity it is worthwhile to understand that the fulfillment of the condition with respect to the second reference value may be understood to correspond to a situation that the generated second estimation exceeds, or equals, to the second reference in value. Alternatively, it may be arranged that the fulfillment of the condition with respect to the second reference value may correspond to a situation that the second estimation is less, or equals, than the second reference in value. The implementation depends on the way how the second estimation is generated 310. In a typical implementation the fulfillment of the condition is judged if the second estimation exceeds the second reference value, i.e. the aggregate probability exceeds the second reference value.

The second reference value is advantageously selected so that it is equal to or preferably larger than the first reference value in the implementation the compared values shall exceed the respective references in order to decide the fulfillment of the condition. In the other implementation in which the compared values shall be below to the respective references the second reference value shall be smaller than the first reference value. In accordance with any of the implementations the aim is to set, or define, the second reference value so that it requires larger aggregate need of the elevator service than the first reference value in order to decide that the condition is fulfilled to provide the elevator service. The selection of the reference values and their mutual relationship may be based on desired triggering levels in causing the described operations to occur in the elevator system 100. Moreover, in some example embodiments the first and the second reference values are dependent on the environment where the elevator system 100 is installed to even on a floor level in the same premises. The values may take into account a type of the area 220, i.e. into which kind of environment, such as a corridor or a lobby, the predefined area 220 is defined and/or what is a level of traffic therein. The reference values may e.g. be established based on historical data representing the human traffic in the predefined area as well as utilization rate of the elevator system 100 in the premises and/or at the floors for which the references are defined. Moreover, the reference values may be dependent on a time of a day, i.e. they may be set differently for different times of the day.

With respect to the second phase in the method as shown in FIG. 4 it is the same as already mentioned in the context of the first reference value that in at least some implementations the second estimation combining the individuals' estimations may be an average value calculated from the summed individual estimation values divided by a number of individuals in the predefined area 220. This is advantageous approach since the number of individuals in the area 220 may vary and, therefore, some statistical value, such as the average value, as a representative of the aggregate value is preferred since it helps in selecting the second reference value. Another option is of course to adjust the second reference value in accordance with the number of individuals detected in the predefined area 220 prior to the comparison 420 is done.

In the description of at least some embodiments of the invention it is mainly referred to an implementation in which the determination of the first estimation and the second estimation are performed by evaluating the same characteristics of the individuals in the predefined area 220 for both evaluations. However, it may also be arranged that different characteristics may be weighed in different ways in the calculations of the first and the second estimation in order to optimize the operation of the present invention even more accurately. It may also be arranged that some characteristics are not taken into account at all in at least one of the estimations.

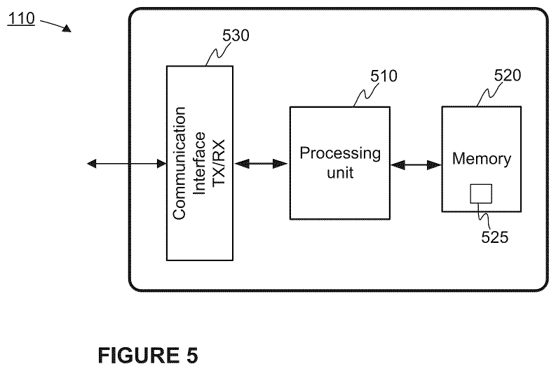

As already mentioned, the aspects of the present invention described herein are mainly done by referring to an implementation in which the controlling entity is a control system 110 of an elevator system 100 as shown in FIG. 1. However, as already mentioned, the functionality of the control system 110 may also be integrated to another computing device or arranged as a separate computing device to the elevator system 100. An example of such an apparatus configurable to implement the operation of the computing device, and, thus, the control system 110, is schematically illustrated in FIG. 5. In other words, the control system 110 may be configured to perform the method according to the invention as described with the examples in the foregoing description. In other words, the apparatus of FIG. 5 may be configured to perform a function to manage the elevator service to a floor by an elevator system 100. For sake of clarity, it is worthwhile to mention that the block diagram of FIG. 5 depicts some components of an entity that may be employed to implement a functionality of the apparatus. The apparatus of FIG. 5 comprises a processor 510 and a memory 520. The memory 520 may store data, such as pieces of data as described, but also computer program code 525 causing the arranging of management of the elevator service in the described manner. The apparatus may further comprise a communication interface 530, such as a wireless communication interface or a communication interface for wired communication, or both to communicate with other entities as described. The communication interface 530 may thus comprise one or more modems, antennas, and any other hardware and software for enabling an execution of the communication e.g. under control of the processor 510. Furthermore, I/O (input/output) components may be arranged, together with the processor 510 and a portion of the computer program code 525, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 520 and at least a portion of the computer program code 525 stored therein may further be arranged, with the processor 510, to cause the apparatus to perform at least a portion of a method as is described herein. The processor 510 may be configured to read from and write to the memory 520. Although the processor 510 is depicted as a respective single component, it may be implemented as respective one or more separate processing components. Similarly, although the memory 520 is depicted as a respective single component, it may be implemented as respective one or more separate components, some, or all of which may be integrated/removable and/or may provide permanent/semi-permanent/dynamic/cached storage.

The computer program code 525 may comprise computer-executable instructions that implement functions that correspond to steps implemented in the method when loaded into the processor 510 of the respective control system 110. As an example, the computer program code 525 may include a computer program consisting of one or more sequences of one or more instructions. The processor 510 is able to load and execute the computer program by reading the one or more sequences of one or more instructions included therein from the memory 520. The one or more sequences of one or more instructions may be configured to, when executed by the processor 510, cause the apparatus to perform a method as described. Hence, the apparatus may comprise at least one processor 510 and at least one memory 520 including the computer program code 525 for one or more programs, the at least one memory 520 and the computer program code 525 configured to, with the at least one processor 510, cause the apparatus implementing the control system 110 to perform the method.

The computer program code 525 may be provided e.g. a computer program product comprising at least one computer-readable non-transitory medium having the computer program code 525 stored thereon, which computer program code 525, when executed by the processor 510 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the control system 110 may also be implemented with a plurality of apparatuses, such as the one schematically illustrated in FIG. 5, as a distributed computing environment corresponding to a control system. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described. For example, some steps of the method may be shared between an elevator controller and a computing device e.g. configured to analyze measurement data obtained from the sensor(s) 210.

As already mentioned, the approach achieved with the present invention at least allows an optimization of the managing the elevator system 100 so that the service provision may be prepared even if the input based on which the decision-making of the service provision is not necessarily accurate as may be the case when evaluating individuals' characteristics from measurement data. It may also be arranged that the mechanism according to the present invention is overruled if one individual explicitly indicates a need of the elevator service e.g. by using user interface of the elevator system 100 to generate service calls.

The specific examples provided in the description given above should not be construed as limiting the applicability and/or the interpretation of the appended claims. Lists and groups of examples provided in the description given above are not exhaustive unless otherwise explicitly stated.

1. A method for managing an elevator service to a floor by an elevator system, the method, performed by a control system, comprises:
generating a first estimation on an aggregate need of an elevator service for a group of individuals in a predefined area, the aggregate need for the group of individuals is generated by combining a number of estimations descriptive on a need of the elevator service by each individual in the predefined area at a first instant of time,
comparing the first estimation to a first reference value,
generating a first control signal to reserve a number of elevators belonging to the elevator system to serve a section the floor belongs to in response to a detection that the first estimation fulfills a condition defined by the first reference value.

2. The method according to claim 1, the method further comprises:
generating a second estimation on the aggregate need of an elevator service for a group of individuals in the predefined area, the aggregate need for the group of individuals is generated by combining a number of estimations descriptive on a need of the elevator service by each person in the predefined area at a second instant of time,
comparing the second estimation to a second reference value,
performing, in accordance with a comparison between the second estimation to the second reference value, one of: i) generate a second control signal to instruct at least one elevator among the number of the elevators reserved to serve the section the floor belongs to, ii) release the number of the elevators reserved to serve the section the floor belongs to.

3. The method according to claim 1, wherein the number of estimations descriptive on a need of the elevator service by each individual in the predefined area is generated based on data obtained from one or more sensors arranged to monitor the predefined area.

4. The method according to claim 3, wherein the one or more sensors are image capturing devices.

5. The method according to claim 1, wherein a number of characteristics of an individual is evaluated to generate the estimation descriptive on the need of the elevator service by the individual.

6. The method according to claim 5, wherein the number of characteristics of the individual comprises at least one of the following: a location of the individual in the predefined area; a movement of the individual in the predefined area; a posture of the individual; a gaze direction of the individual.

7. The method according to claim 1, wherein the first estimation and the second estimation is determined to express a probability of the aggregate need of the elevator service by the group of individuals.

8. The method according to claim 1, wherein the first estimation and the second estimation are expressed as a statistical value with respect to an individual in the predefined area.

9. The method according to claim 1, wherein the second reference value is defined to require larger aggregate need of the elevator service than the first reference value.

10. A control system for managing an elevator service to a floor by an elevator system, the control system configured to:
generate a first estimation on an aggregate need of an elevator service for a group of individuals in a predefined area, the aggregate need for the group of individuals is generated by combining a number of estimations descriptive on a need of the elevator service by each individual in the predefined area at a first instant of time,
compare the first estimation to a first reference value, generate a first control signal to reserve a number of elevators belonging to the elevator system to serve a section the floor belongs to in response to a detection that the first estimation fulfills a condition defined by the first reference value.

11. The control system according to claim 10, the control system further configured to:
generate a second estimation on the aggregate need of an elevator service for a group of individuals in the predefined area, the aggregate need for the group of individuals is generated by combining a number of estimations descriptive on a need of the elevator service by each person in the predefined area at a second instant of time,
compare the second estimation to a second reference value,
perform, in accordance with a comparison between the second estimation to the second reference value, one of: i) generate a second control signal to instruct at least one elevator among the number of the elevators reserved to serve the section the floor belongs to, ii) release the number of the elevators reserved to serve the section the floor belongs to.

12. The control system according to claim 10, wherein the control system is configured to generate the number of estimations descriptive on a need of the elevator service by each individual in the predefined area based on data obtained from one or more sensors arranged to monitor the predefined area.

13. The control system according to claim 12, wherein the control system is configured to obtain the data from one or more sensors being image capturing devices.

14. The control system according to claim 1, wherein the control system is configured to evaluate a number of characteristics of an individual to generate the estimation descriptive on the need of the elevator service by the individual.

15. The control system according to claim 14, wherein the number of characteristics of the individual comprises at least one of the following: a location of the individual in the predefined area; a movement of the individual in the predefined area; a posture of the individual; a gaze direction of the individual.

16. The control system according to claim 1, wherein the control system is configured to determine the first estimation and the second estimation to express a probability of the aggregate need of the elevator service by the group of individuals.

17. The control system according to claim 1, wherein the control system is configured to express the first estimation and the second estimation as a statistical value with respect to an individual in the predefined area.

18. The control system according to claim 1, wherein the second reference value is defined to require larger aggregate need of the elevator service than the first reference value.

19. An elevator system comprising:
a number of elevators,
a control system according to claim 1.

20. The elevator system according to claim 19, the elevator system further comprising one or more sensors configured to obtain data for generating a number of estimations descriptive on a need of the elevator service by each individual in the predefined area.

21. A non-transitory computer readable medium storing a computer program comprising computer readable program code configured to cause performing of the method according to claim 1 when the computer readable program code is run on one or more computing apparatuses.
